(19) United States
(12) Patent Application Publication
(10) Pub. No.: US 2007/0132866 A1
(43) Pub. Date: Jun. 14, 2007

(54) Image capture device and method, and recording medium storing program for performing the method

(75) Inventors: Sanga-jin Lee, Seoul (KR); Moon-cheol Kim, Suwon-si (KR); Jin-sub Um, Suwon-si (KR); Chang-woo Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/592,154

(22) Filed: Nov. 3, 2006

(30) Foreign Application Priority Data
Dec. 10, 2005 (KR) 10-2005-0121248

(51) Int. Cl. H04N 5/202

(52) U.S. Cl. 348/254

(57) ABSTRACT

An image capture device and method for capturing an image with color distortion minimized based on a wide color gamut and an image having color properties appropriate to various standards, and a recording medium storing a program for performing the method. The image capture device includes a first conversion unit converting an input image signal into an RGB signal having a wide color gamut, a gamma correction unit performing gamma correction on the RGB signal using gamma curve information determined according to an output format of the image capture device, and a second conversion unit converting a color domain of the gamma corrected RGB signal into a luminance and chrominance signal having a color domain determined according to the output format of the image capture device, using a color domain conversion matrix.

### CROSS-REFERENCE TO RELATED PATENT APPLICATIONS

This application claims the benefit of Korean Patent Application No. 10-2005-0121248, filed on Dec. 10, 2005, in the Korean Intellectual Property Office, the disclosure of which is incorporated herein in its entirety by reference.

### BACKGROUND OF THE INVENTION

1. Field of the Invention

The present invention relates to an image capture device, and more particularly, to an image capture device and method for capturing an image base on a color gamut, and a recording medium storing a program for performing the method.

2. Description of the Related Art

An image capture device includes a camcorder or a camera. The image capture device receives an image through an imaging device such as a charge-coupled device or a complementary metal-oxide semiconductor (CMOS) sensor and converts an input image signal into an RGB signal using linear matrix transformation. Here, signals beyond a color gamut according to standards such as sRGB/Rec. and ITU-RBT.709 are generated. The color gamut is the range of colors that can be accurately represented when an image captured in the image capture device is reproduced. Accordingly, the color gamut is determined according to the display standard of an image reproducing device (or a display device). Signals beyond the color gamut means signals beyond the range of colors that can be represented during reproduction.

A conventional image capture device clips an RGB signal using the boundary of the color gamut, performs gamma correction of the clipped RGB signal, and converts the gamma-corrected RGB signal into a YCbCr signal. The conventional image capture device clips the entire RGB signal including all of the signals beyond the color gamut, and therefore, when the image signal received through an imaging device has so many signals beyond the color gamut, the image captured by the conventional image capture device has much color distortion. As a result, when the image captured by the conventional image capture device is reproduced, reproduction of colors of the image is much different from that according to human visual characteristics.

### SUMMARY OF THE INVENTION

The present invention provides an image capture device and method for capturing an image with color distortion minimized based on a wide color gamut, and a recording medium storing a program for performing the method.

The present invention also provides an image capture device and method for capturing an image having color properties appropriate to diverse standards, and a recording medium storing a program for performing the method.

According to an aspect of the present invention, there is provided an image capture device including a first conversion unit converting an input image signal into an RGB signal having a wide color gamut, a gamma correction unit performing gamma correction on the RGB signal using gamma curve information determined according to an output format of the image capture device, and a second conversion unit converting a color domain of the gamma corrected RGB signal into a luminance and chrominance signal having a color domain determined according to the output format of the image capture device, using a color domain conversion matrix.

The image capture device may further include a gamut clipping/mapping unit performing gamut clipping on the luminance and chrominance signal output from the second conversion unit based on a wide color gamut clipping range corresponding to the output format or performing gamut mapping on the luminance and chrominance signal output from the second conversion unit based on the wide color gamut clipping range corresponding to the output format and a clipping ratio.

According to another aspect of the present invention, there is provided an image capture method for an image capture device. The image capture method includes converting an input image signal into an RGB signal having a wide color gamut; performing gamma correction on the RGB signal using gamma curve information determined according to an output format of the image capture device; and converting a color domain of the gamma corrected RGB signal into a luminance and chrominance signal having a color domain determined according to the output format of the image capture device, using a color domain conversion matrix, and outputting the luminance and chrominance signal.

The image capture method may further include performing gamut clipping on the luminance and chrominance signal based on a wide color gamut clipping range corresponding to the output format of the image capture device or performing gamut mapping on the luminance and chrominance signal based on the wide color gamut clipping range corresponding to the output format and a clipping ratio.

According to still another aspect of the present invention, there is provided a computer readable recording medium for storing a program performing an image capture method in an image capture device. The computer readable recording medium includes a code for converting an input image signal into an RGB signal having a wide color gamut; a code for performing gamma correction on the RGB signal using gamma curve information determined according to an output format of the image capture RGB signal into a luminance and chrominance signal having a color domain determined according to the output format of the image capture device, using a color domain conversion matrix, and outputting the luminance and chrominance signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a functional block diagram of an image capture device according to an embodiment of the present invention;

FIG. 2 illustrates a gamma curve according to Recommendation ITU-R BT.1361;

FIG. 3 illustrates a gamma curve according to an xvYCC standard;

FIG. 4 is a functional block diagram of an image capture device according to another embodiment of the present invention;

FIG. 5 illustrates an example of comparison between a luminance signal and a chrominance signal having a wide color gamut and an sRGB color gamut in 8-bit resolution;

FIG. 6 is a functional block diagram of an image capture device according to still another embodiment of the present invention;

FIG. 7 is a detailed block diagram of a gamma correction unit and a second conversion unit shown in FIG. 6;

FIG. 8 is a functional block diagram of an image capture device according to yet another embodiment of the present invention;

FIG. 9 is a flowchart of an image capture method according to an embodiment of the present invention; and

FIG. 10 is a flowchart of an image capture method according to another embodiment of the present invention.

### DETAILED DESCRIPTION OF THE INVENTION

Hereinafter, preferred embodiments of the present invention will be described in detail with reference to the attached drawings. In the drawings, the same reference numerals denote the same elements throughout.

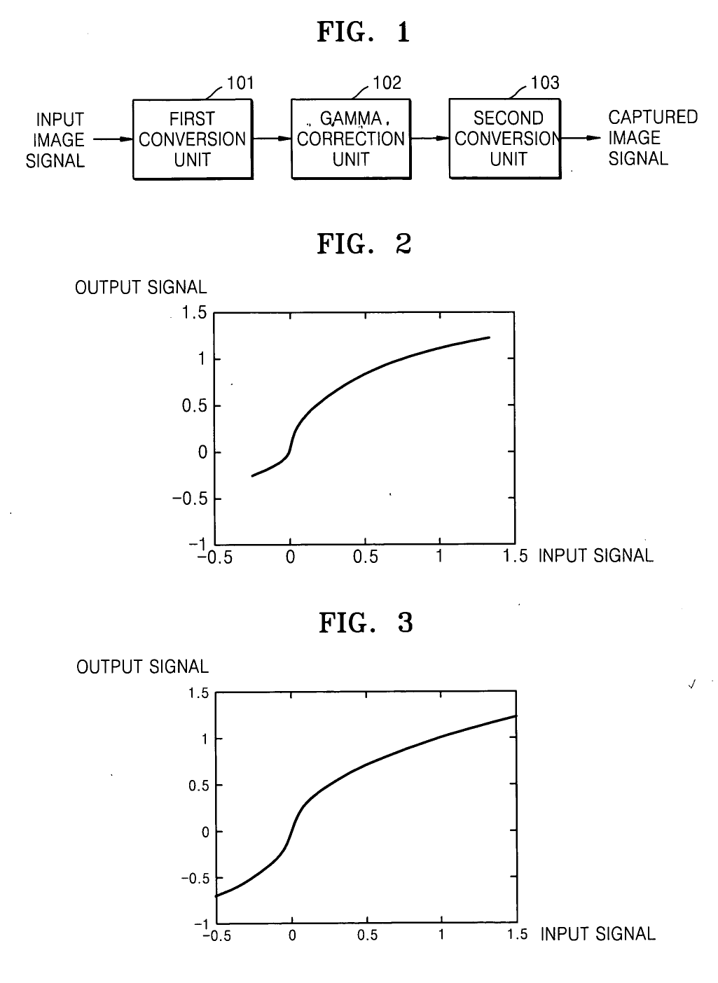

FIG. 1 is a functional block diagram of an image capture device according to an embodiment of the present invention. Referring to FIG. 1, the image capture device includes a first conversion unit 101, a gamma correction unit 102, and a second conversion unit 103.

When an image signal having a linear characteristic is input through an imaging device (not shown), the first conversion unit 101 converts the input image signal into an RGB signal having a wide color gamut using a conversion matrix. Accordingly, the RGB signal output from the first conversion unit 101 includes a signal having a negative value and a signal having a value greater than “1”. The conversion matrix may be obtained using, for example, Least Mean Square Filtering (LMSF) so that a CIE-RGB color matching function can be obtained with respect to the input image signal. The LMSF has a minimum error statistically.

The gamma correction unit 102 receives the RGB signal having the wide color gamut from the first conversion unit 101. Upon receiving the RGB signal, the gamma correction unit 102 performs gamma correction of the RGB signal having the wide color gamut using a gamma curve predetermined according to an output format of the image capture device. For example, when the output format of the image capture device is Recommendation ITU-R BT.1361, the gamma correction unit, 102 performs the gamma correction of the RGB signal based on a gamma curve illustrated in FIG. 2. FIG. 2 illustrates a gamma curve according to the Recommendation ITU-R BT.1361. Referring to FIG. 2, an input signal is an RGB signal having the wide color gamut and an output signal is a gamma corrected RGB signal. The gamma curve illustrated in FIG. 2 may be defined as Equation (1):
E′=1.099×L^{0.45}−0.099 for 0.018≦L
E′=4.50×L for −0.018≦L<0.018
E′=−(1.099×(−L)^{0.45}−0.099) for L<−0.018, (1)
where L denotes the RGB signal having the wide color gamut, which is input to the gamma correction unit 102; and E′ denotes the gamma corrected RGB signal output from the gamma correction unit 102.

When the output format of the image capture device is of an xvYCC standard, the gamma correction unit 102 performs the gamma correction of the RGB signal based on a gamma curve illustrated in FIG. 3. FIG. 3 illustrates a gamma curve according to the xvYCC standard. Referring to FIG. 3, an input signal is an RGB signal having the wide color gamut and an output signal is a gamma corrected RGB signal. The gamma curve illustrated in FIG. 3 may be defined as Equation (2):
E′=1.099×L^{0.45}−0.099 for 0.018≦L<1.33
E′=4.50×L for −0.0045≦L<0.018
E′=−{1.099−(−4×L)^{0.45}−0.099}/4 for −0.25≦L<−0.0045, (2)
where L denotes the RGB signal having the wide color gamut, which is input to the gamma correction unit 102; and E′ denotes the gamma corrected RGB signal output from the gamma correction unit 102.

The image capture device may have an output format other than the xvYCC standard or the Recommendation ITU-R BT.1361. The output format of the image capture device is determined according to a display format of a device for reproducing an image captured by the image capture device.

The second conversion unit 103 receives the gamma corrected RGB signal from the gamma correction unit 102. Upon receiving the gamma corrected RGB signal, the second conversion unit 103 converts the color domain of the gamma corrected RGB signal into a luminance signal and a chrominance signal (YCbCr or YUV) having a color domain determined according to the output format of the image capture device using a color domain conversion matrix.

The color domain conversion matrix is predetermined according to the output format of the image capture device. For example, when the output format is sRGB, the color domain conversion matrix is configured to convert the color domain of the gamma corrected RGB signal into a luminance signal and a chrominance signal having an sRGB color domain. When the output format is sYCC, the color domain conversion matrix is configured to convert the color domain of the gamma corrected RGB signal into a luminance signal and a chrominance signal having an sYCC color domain. When the output format is xvYCC, the color domain conversion matrix is configured to convert the color domain of the gamma corrected RGB signal into a luminance signal and a chrominance signal having an xvYCC color domain. The luminance and chrominance signals are output as captured image signals. The output format may be one other than sRGB, sYCC, and xvYCC.

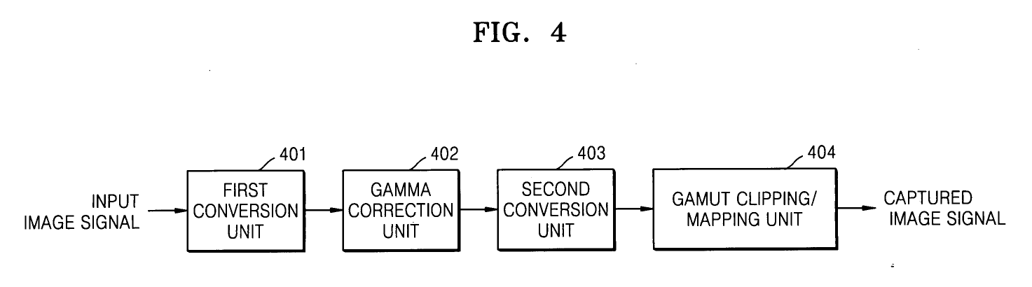

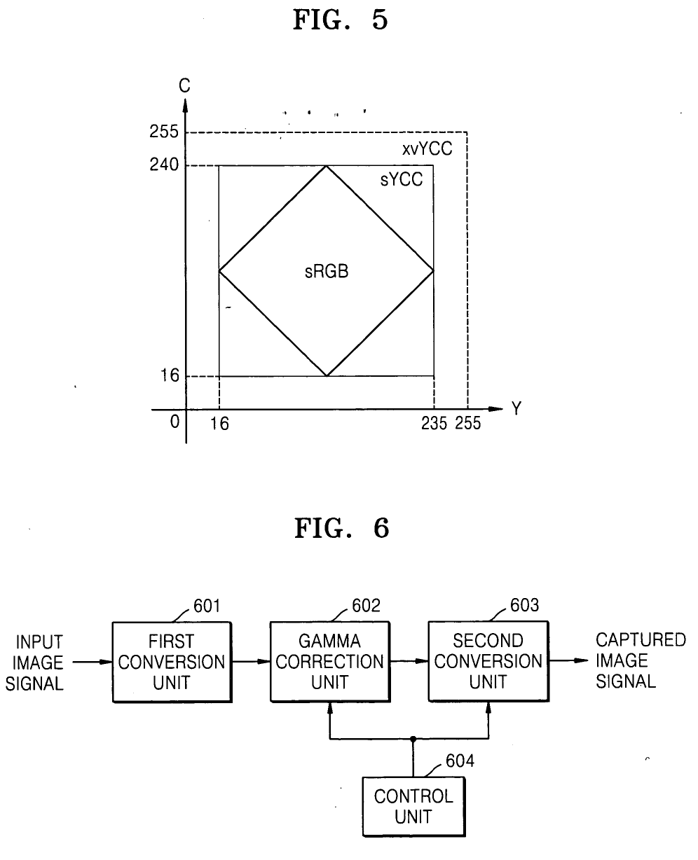

FIG. 4 is a functional block diagram of an image capture device according to another embodiment of the present invention. Referring to FIG. 4, the image capture device includes a first conversion unit 401, a gamma correction unit 402, a second conversion unit 403, and a gamut clipping/mapping unit 404.

The first conversion unit 401, the gamma correction unit 402, and the second conversion unit 403 illustrated in FIG. 4 are the same as the first conversion unit 101, the gamma correction unit 102, and the second conversion unit 103 illustrated in FIG. 1.

The gamut clipping/mapping unit 404 is implemented as a gamut clipping unit or a gamut mapping unit. When the gamut clipping/mapping unit 404 is implemented as the gamut clipping unit, the gamut clipping/mapping unit 404 clips a signal beyond the wide color gamut among the luminance and chrominance signals transmitted from the second conversion unit 403 and outputs a result of the clipping as a captured image signal. The wide color gamut may vary with the output format of the image capture device.

FIG. 5 illustrates an example of a comparison between a luminance signal Y and a chrominance signal C having a wide color gamut and an sRGB color gamut in 8-bit resolution. Referring to FIG. 5, when the output format of the image capture device is sYCC, the luminance signal Y beyond a range of 16-235 is a signal beyond the wide color gamut and is subjected to gamut clipping. The chrominance signal C beyond a range of 16-240is also a signal beyond the wide color gamut and is subject to gamut clipping. When the output format of the image capture device is xvYCC, the luminance signal Y and the chrominance signal C which are beyond a range of 1-254 are signals beyond the wide color gamut and are subject to gamut clipping. In the case of xvYCC, “0” and “255” are used as synchronizing signals and are not included in an effective signal range. When the output format of the image capture device is sRGB, wide color gamut clipping is performed based on the sRGB area. For clarity of the description, clipping ranges for the luminance signal Y and the chrominance signal C are specified in FIG. 5. However, the clipping ranges may vary with the image capture device and display conditions of an image reproducing device corresponding to the image capture device.

When the gamut clipping/mapping unit 404 is implemented as the gamut mapping unit, the gamut clipping/mapping unit 404 clips the value of a luminance signal and the value of a chrominance signal based on a wide color gamut clipping range set according to the output format of the image capture device, monitors clipping ratios for the luminance signal and the chrominance signal, and performs gamut mapping between the clipped luminance signal and the clipped chrominance signal so that color tone or brightness of a reproduced image is maintained constant.

For example, when the output format of the image capture device is sYCC, if a chrominance signal Cb has a value of 250 and a chrominance signal Cr has a value of 220, 10 of the chrominance signal Cb is clipped (to 240) based on the wide color gamut clipping range while the chrominance signal Cr is not clipped because it is within the wide color gamut clipping range. Since 4% of the chrominance signal Cb is clipped while none of the chrominance signal Cr is clipped, the color tone of a reproduced image may not be constant. In this situation, the gamut clipping/mapping unit 404 performs the gamut clipping between the chrominance signals Cb and Cr so that 4% of the chrominance signal Cr is clipped. During gamut mapping, the clipping ratios may be different. For example, when the clipping ratio for the chrominance signal Cb is 4%, the clipping ratio for the chrominance signal Cr may not be necessarily 4% but may be different from the clipping ratio for the chrominance signal Cb. The clipping ratios may be set differently so long as the color tone or brightness of a reproduced image is maintained constant.

A result of the operation of the gamut clipping/mapping unit 404 is output as a captured image signal of the image capture device.

FIG. 6 is a functional block diagram of an image capture device according to still another embodiment of the present invention. Referring to FIG. 6, the image capture device includes a first conversion unit 601, a gamma correction unit 602, a second conversion unit 603, and a control unit 604.

The first conversionunit 601 is the same as the first conversion unit 101 illustrated in FIG. 1.

The gamma correction unit 602 may include a plurality of gamma curve tables or may be designed such that gamma curve information is updated according to an output format set in the image capture device.

In the case where the gamma correction unit 602 includes a plurality of gamma curve tables, the plurality of gamma curve tables are set according to the output formats that can be set in the image capture device. For example, when sRGB, sYCC, and xvYCC can be set as an output format in the image capture device, gamma curve tables corresponding to the output formats, sRGB, sYCC, and xvYCC, are included in the gamma correction unit 602. When the number of output formats that can be set in the image capture device is “n”, the gamma correction unit 602 includes “n” gamma curve tables respectively corresponding to the “n” output formats. The gamma correction unit 602 outputs a value from one gamma curve table among the plurality of gamma curve tables according to output format information provided from the control unit 604 as a gamma corrected RGB signal with respect to an input RGB signal. The input RGB signal has a wide color gamut.

In the case where the gamma correction unit 602 is designed such that the gamma curve information is updated according to the output format set in the image capture device, upon receiving the gamma curve information from the control unit 604 according to the output format, the gamma correction unit 602 outputs a gamma corrected RGB signal with respect to the input RGB signal based on the received gamma curve information. Here, the gamma correction unit 602 has gamma curve information only corresponding to a single output format. The gamma correction information that the gamma correction unit 602 has is updated with gamma correction information provided from the control unit 604 each time the output format set in the image capture device changes.

The second conversion unit 603 may include a plurality of color domain conversion matrixes or may be designed such that a color domain conversion matrix is updated according to an output format set in the image capture device.

In the case where the second conversion unit 603 includes the plurality of color domain conversion matrixes, the plurality of color domain conversion matrixes are set according to output formats that can be set in the image capture device. For example, when sRGB, sYCC, and xvYCC can be set as an output format in the image capture device, color domain conversion matrixes corresponding to the output formats, sRGB, sYCC, and xvYCC, are included in the second conversion unit 603. When the number of output formats that can be set in the image capture device is “n”, the second conversion unit 603 includes “n” color domain conversion matrixes respectively corresponding to the “n” output formats. The second conversion unit 603 outputs a signal from one color domain conversion matrix among the plurality of color domain conversion matrixes according to output format information provided from the control unit 604 as a luminance and chrominance signal with respect to the input gamma corrected RGB signal. The plurality of color domain conversion matrixes, as in the second conversion unit 103 shown in FIG. 1, convert a color domain of the gamma corrected RGB signal into a luminance and chrominance signal having a color domain set according to the output format of the image capture device.

In the case where the second conversion unit 603 is designed such that the color domain conversion matrix is updated according to the output format set in the image capture device, upon receiving color domain conversion matrix information from the control unit 604 according to the output format, the second conversion unit 603 converts the color domain of the gamma corrected RGB signal into a luminance and chrominance signal having a color domain set according to the output format based on the received color domain conversion matrix information. Here, the second conversion unit 603 has a single color domain conversion matrix corresponding to a single output format. The color domain conversion matrix that the second conversion unit 603 has is updated based on color domain conversion matrix information provided from the control unit 604 each time the output format set in the image capture device changes.

When the gamma correction unit 602 includes a plurality of gamma curve tables and the second conversion unit 603 includes a plurality of color domain conversion matrixes, the control unit 604 provides information on an output format set in the image capture device to the gamma correction unit 602 and the second conversion unit 603. Alternatively, when the gamma correction unit 602 and the second conversion unit 603 respectively include gamma curve information and color domain conversion matrix information which correspond to a single output format, the control unit 604 provides gamma curve information corresponding to an output format set in the image capture device to the gamma correction unit 602 and color domain conversion matrix information corresponding thereto to the second conversion unit 603. The gamma curve information and the color domain conversion matrix information may be provided by the control unit 604 or other units through a communication means such as Inter-Integrated Circuit (I2C) or Joint Test Action Group (J-TAG).

For example, information on a plurality of gamma curves corresponding to output formats that can be set in the image capture device and information on a plurality of color domain conversion matrixes corresponding thereto may be stored in a separate memory (not shown). Then, the control unit 604 may read gamma curve information and color domain conversion matrix information which correspond to a current output format from the memory and provide the two types of information to the gamma correction unit 602 and the second conversion unit 603, respectively. The gamma curve information and the color domain conversion matrix information stored in the memory may be provided to the gamma correction unit 602 and the second conversion unit 603 through a communication means such as I2C or J-TAG without using the control unit 604.

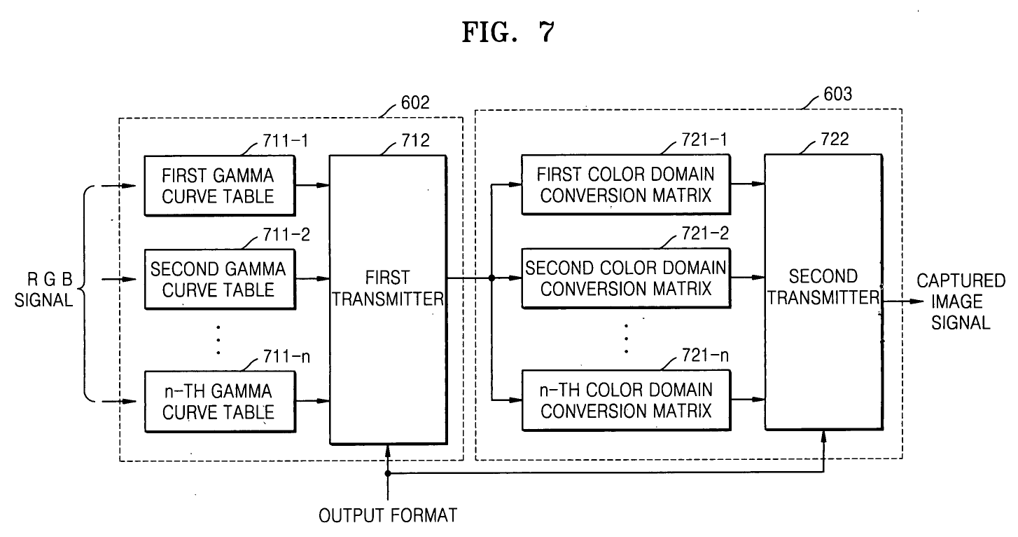

When the gamma correction unit 602 includes a plurality of gamma curve tables and the second conversion unit 603 includes a plurality of color domain conversion matrixes, the gamma correction unit 602 and the second conversion unit 603 have a structure illustrated in FIG. 7. FIG. 7 is a detailed block diagram of the gamma correction unit 602 and the second conversion unit 603 shown in FIG. 6.

Referring to FIG. 7, the gamma correction unit 602 includes first through n-th gamma curve tables 711_1 through 711_n and a first transmitter 712. The first through n-th gamma curve tables 711_1 through 711_n receive an RGB signal having a wide color gamut from the first conversion unit 601. Upon receiving the RGB signal, the first through n-th gamma curve tables 711_1 through 711_n output gamma corrected RGB signals, respectively. Gamma curve information stored in each of the first through n-th gamma curve tables 711_1 through 711_n may include the gamma curve shown in FIG. 2 or 3.

The gamma corrected RGB signals output from the first through n-th gamma curve tables 711_1 through 711_n are transmitted to the first transmitter 712. The first transmitter 712 selects one among the gamma corrected RGB signals received from the first through n-th gamma curve tables 711_1 through 711_n according to an output format of the image capture device and transmits the selected gamma corrected RGB signal to the second conversion unit 603. Information on the output format may be provided from the control unit 604.

The second conversion, unit 603 includes first through n-th color domain conversion matrixes 721_1 through 721_n and a second transmitter 722. The first through n-th color domain conversion matrixes 721_1 through 721_n receive the gamma corrected RGB signal output from the first transmitter 712. Upon receiving the gamma corrected RGB signal, the first through n-th color domain conversion matrixes 721_1 through 721_n respectively output luminance and chrominance signals having a changed color domain. The first through n-th color domain conversion matrixes 721_1 through 721_n operate in the same manner as the second conversion unit 103 shown in FIG. 1. The luminance and chrominance signals output from the first through n-th color domain conversion matrixes 721_1 through 721_n are transmitted to the second transmitter 722.

Information stored in the first through n-th gamma curve tables 711_1 through 711_n and information stored in the first through n-th color domain conversion matrixes 721_1 through 721_n may be updated using the control unit 604 and/or the memory mentioned in the description with reference to FIG. 6. The memory stores information on a plurality of gamma curves and information on a plurality of color domain conversion matrixes.

The second transmitter 722 selects and outputs one among the luminance and chrominance signals respectively received from the first through n-th color domain conversion matrixes 721_1 through 721_n according to the output format of the image capture device. The information on the output format may be provided from the control unit 604. The luminance and chrominance signal selected by the second transmitter 722 is output as a captured image signal.

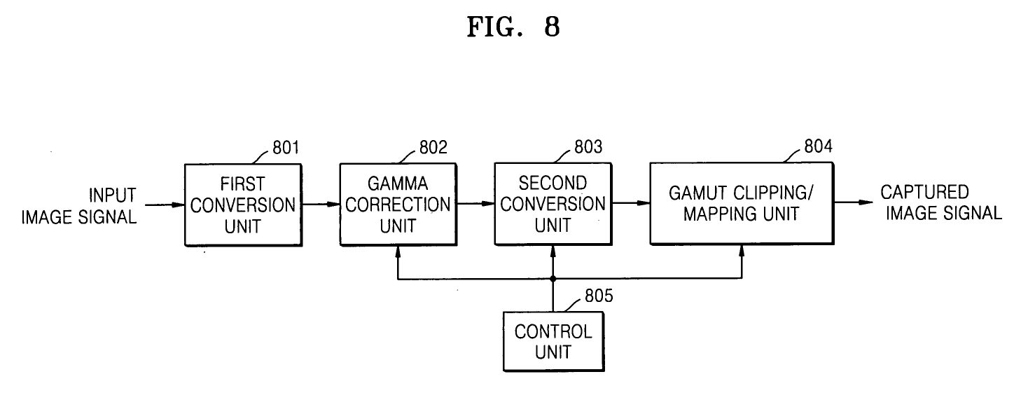

FIG. 8 is a functional block diagram of an image capture device according to yet another embodiment of the present invention. Referring to FIG. 8, the image capture device includes a first conversion unit 801, a gamma correction unit 802, a second conversion unit 803, a gamut clipping/mapping unit 804, and a control unit 805. The first conversion unit 801, the gamma correction unit 802, and the second conversion unit 803 shown in FIG. 8 are the same as the first conversion unit 601, the gamma correction unit 602, and the second conversion unit 603 shown in FIG. 6.

The gamut clipping/mapping unit 804 shown in FIG. 8 is the same as the gamut clipping/mapping unit 404 shown in FIG. 4.

The control unit 805 provides information on an output format of the image capture device to the gamma correction unit 802 and the second conversion unit 803. In addition, the control unit 805 may provide gamma curve information and color domain conversion matrix information to the gamma correction unit 802 and the second conversion unit 803, respectively, according to the output format of the image capture device. The control unit 805 may also provide the information on the output format of the image capture device and wide color gamut information corresponding to the output format or the wide color gamut information and information for gamut mapping to the gamut clipping/mapping unit 804.

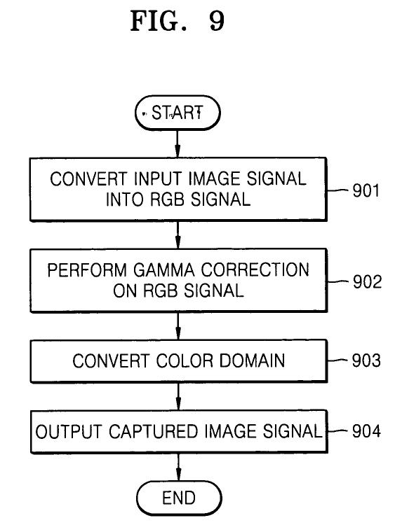

FIG. 9 is a flowchart of an image capture method according to an embodiment of the present invention. Referring to FIG. 9, when an image signal is input through an imaging device (not shown), the input image signal is converted into an RGB signal having a wide color gamut in operation 901. The conversion from the input image signal to the RGB signal is performed by the first conversion unit 101 shown in FIG. 1, as described above.

In operation 902, gamma correction is performed on the RGB signal having the wide color gamut based on gamma curve information corresponding to an output format of an image capture device. As described with reference to FIG. 6, the gamma curve information may be updated according to a current output format of the image capture device or may include all gamma curves corresponding to output formats that can be set in the image capture device. The gamma correction of the RGB signal having the wide color gamut may be performed in the same manner as that performed by the gamma correction unit 102 described with reference to FIG. 1. When the gamma correction information includes all of the gamma curves corresponding to the available output formats, the gamma correction is performed using a gamma curve corresponding to the current output format of the image capture device.

In operation 903, a color domain of the gamma corrected RGB signal is converted into a luminance and chrominance signal having a color domain set according to the current output format of the image capture device. For this conversion, a color domain conversion matrix described with reference to FIGS. 1, 4, 6, 7, and 8 is used according to the current output format of the image capture device.

In operation 904, a signal obtained in operation 903 is output as a captured image signal.

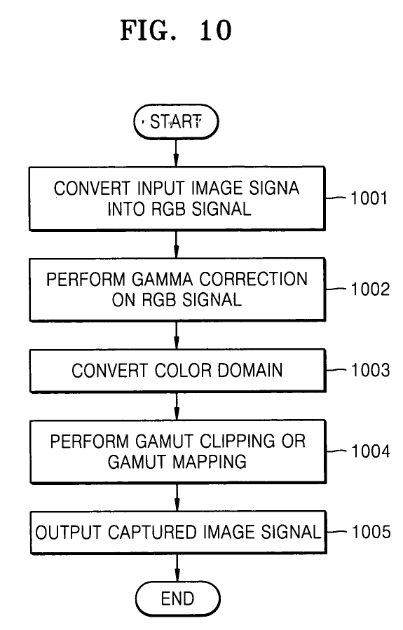

FIG. 10 is a flowchart of an image capture method according to another embodiment of the present invention. Operations 1001 through 1003 are the same as the operations 901 through 903 shown in FIG. 9. Accordingly, in operation 1003, a luminance and chrominance signal having a color domain corresponding to a current output format of an image capture device is produced. The luminance and chrominance signal has a wide color gamut. In operation 1004, gamut clipping is performed on the luminance and chrominance signal based on a wide color gamut clipping range corresponding to the current output format of the image capture device or gamut mapping is performed on the luminance and chrominance signal based on the wide color gamut clipping range corresponding to the current output format of the image capture device and clipping ratios. The gamut clipping and the gamut mapping is performed in the same manner as that performed by the gamut clipping/mapping unit 404 described with reference to FIG. 4.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy. disks, optical data storage devices, and carrier waves (such as data transmission through the Internet). The computer readable recording medium can also be distributed over network coupled computer systems so that the computer readable code is stored and executed in a distributed fashion.

As described above, the present invention provides an image with minimized color distortion based on a wide color gamut so that color reproduction according to human visual characteristics is possible when an image captured by an image capture device is reproduced. In addition, the present invention selectively uses a gamma curve and a color domain conversion matrix according to an output format, thereby providing an image capture device that can provide image signals having color properties appropriate to various standards, for example, the sRGB standard, the sYCC standard, and the xvYCC standard.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An image capture device comprising:
a first conversion unit converting an input image signal into an RGB signal having a wide color gamut;
a gamma correction unit performing gamma correction on the RGB signal using gamma curve information determined according to an output format of the image capture device; and
a second conversion unit converting a color domain of the gamma corrected RGB signal into a luminance and chrominance signal having a color domain determined according to the output format of the image capture device, using a color domain conversion matrix.

2. The image capture device of claim 1, wherein the gamma correction unit updates the gamma curve information each time the output format of the image capture device changes.

3. The image capture device of claim 2, wherein the second conversion unit updates the color domain conversion matrix each time the output format of the image capture device changes.

4. The image capture device of claim 1, further comprising a control unit providing information on the output format of the image capture device,
wherein the gamma correction unit comprises:
a plurality of gamma curve tables respectively corresponding to a plurality of output formats that can be set in the image capture device; and
a first transmitter selecting a signal from one gamma curve table among the plurality of gamma curve tables according to the output format of the image capture device and transmitting the signal to the second conversion unit, and
each of the gamma curve tables receives the RGB signal output from the first conversion unit.

5. The image capture device of claim 4, wherein the second conversion unit comprises:
a plurality of color domain conversion matrixes respectively corresponding to the plurality of output formats that can be set in the image capture device; and
a second transmitter selecting and outputting a signal from one color domain conversion matrix among the plurality of color domain conversion matrixes according to the output format of the image capture device, and
each of the color domain conversion matrixes receives the gamma corrected RGB signal output from the first transmitter.

6. The image capture device of claim 5, further comprising a gamut clipping/mapping unit performing gamut clipping on the luminance and chrominance signal output from the second conversion unit based on a wide color gamut clipping range corresponding to the output format, or performing gamut mapping on the luminance, and chrominance signal output from the second conversion unit based on the wide color gamut clipping range corresponding to the output format and a clipping ratio.

7. The image capture device of claim 3, further comprising a gamut clipping/mapping unit performing gamut clipping on the luminance and chrominance signal output from the second conversion unit based on a wide color gamut clipping range corresponding to the output format, or performing gamut mapping on the luminance and chrominance signal output from the second conversion unit based on the wide color gamut clipping range corresponding to the output format and a clipping ratio.

8. The image capture device of claim 1, further comprising a gamut clipping/mapping unit performing gamut clipping on the luminance and chrominance signal output from the second conversion unit based on a wide color gamut clipping range corresponding to the output format, or performing gamut mapping on the luminance and chrominance signal output from the second conversion unit based on the wide color gamut clipping range corresponding to the output format and a clipping ratio.

9. An image capture method for an image capture device, comprising:
converting an input image signal into an RGB signal having a wide color gamut;
performing gamma correction on the RGB signal using gamma curve information determined according to an output format of the image capture device; and
converting a color domain of the gamma corrected RGB signal into a luminance and chrominance signal having a color domain determined according to the output format of the image capture device, using a color domain conversion matrix, and outputting the luminance and chrominance signal.

10. The image capture method of claim 9, wherein the gamma curve information is updated each time the output format of the image capture device changes.

11. The image capture method of claim 9, wherein the color domain conversion matrix is updated each time the output format of the image capture device changes.

12. The image capture method of claim 9, wherein the performing of the gamma correction comprises:
selecting one gamma corrected RGB signal among a plurality of gamma corrected RGB signals obtained using gamma curve information corresponding to a plurality of output formats of the image capture device; and
outputting the selected gamma corrected RGB signal.

13. The image capture method of claim 12, wherein the converting of the color domain of the gamma corrected RGB signal comprises:
selecting one luminance and chrominance signal among a plurality of luminance and chrominance signals obtained using a plurality of color domain conversion matrixes respectively corresponding to the plurality of output formats; and
outputting the selected luminance and chrominance signal.

14. The image capture method of claim 13, further comprising performing gamut clipping on the luminance and chrominance signal based on a wide color gamut clipping range corresponding to the output format of the image capture device, or performing gamut mapping on the luminance and chrominance signal based on the wide color gamut clipping range corresponding to the output format and a clipping ratio.

15. The image capture method of claim 11, further comprising performing gamut clipping on the luminance and chrominance signal based on a wide color gamut clipping range corresponding to the output format of the image capture device, or performing gamut mapping on the luminance and chrominance signal based on the wide color gamut clipping range corresponding to the output format and a clipping ratio.

16. The image capture method of claim 9, further comprising performing gamut clipping on the luminance and chrominance signal based on a wide color gamut clipping range corresponding to the output format of the image capture device, or performing gamut mapping on the luminance and chrominance signal based on the wide color gamut clipping range corresponding to the output format and a clipping ratio.

17. A computer readable recording medium for storing a program performing an image capture method in an image capture device, the computer readable recording medium comprising:
a code for converting an input image signal into an RGB signal having a wide color gamut;
a code for performing gamma correction on the RGB signal using gamma curve information determined according to an output format of the image capture device; and
a code for converting a color domain of the gamma corrected RGB signal into a luminance and chrominance signal having a color domain determined according to the output format of the image capture device, using a color domain conversion matrix, and outputting the luminance and chrominance signal.

18. The image capture method of claim 17, further comprising a code for performing gamut clipping on the luminance and chrominance signal based on a wide color gamut clipping range corresponding to the output format of the image capture device, or performing gamut mapping on the luminance and chrominance signal based on the wide color gamut clipping range corresponding to the output format and a clipping ratio.
